(19) United States
(12) Patent Application Publication
(10) Pub. No.: US 2025/0274159 A1
(43) Pub. Date: Aug. 28, 2025

(54) METHOD FOR CONVERTING PHASE OF COMMUNICATION SIGNAL AND ELECTRONIC DEVICE

(71) Applicant: Samsung Electronics Co., Ltd., Suwon-si (KR)

(72) Inventor: Yongjun AN, Suwon-si (KR)

(21) Appl. No.: 19/205,587

(22) Filed: May 12, 2025

Related U.S. Application Data
(63) Continuation of application No. PCT/KR2023/018297, filed on Nov. 14, 2023.

(30) Foreign Application Priority Data
Nov. 14, 2022 (KR) 10-2022-0151857
Dec. 14, 2022 (KR) 10-2022-0175123

(51) Int. Cl. H04B 1/40; H01Q 3/36; H04W 64/00; H04W 84/06

(52) U.S. Cl. CPC H04B 1/40; H01Q 3/36; H04W 64/00; H04W 84/06

(57) ABSTRACT

An electronic device may comprise: a communication module comprising a first antenna and a second antenna such that circular polarization-type communication signals are implemented based on the first and second antennas, a motion sensor, a memory, and at least one processor, comprising processing circuitry, operatively connected to the communication module, the motion sensor, and the memory. The processor may identify a first position of the electronic device through the communication module; identify a second position of a first external electronic device having communication connection through the communication module based on satellite-related information stored in the memory; calculate a relative direction with regard to the first external electronic device disposed in the second position using the electronic device disposed in the first position as a reference point; identify the state of the electronic device according to the calculated direction using the motion sensor; in response to the identified state of the electronic device, one from among a first circulation polarization type rotating along a first direction and a second circulation polarization type rotating along a second direction opposite to the first direction based on the first and second antennas; and generate a communication signal corresponding to the determined circulation polarization type.

### CROSS-REFERENCE TO RELATED APPLICATIONS

This application is a continuation of International Application No. PCT/KR2023/018297 designating the United States, filed on Nov. 14, 2023, in the Korean Intellectual Property Receiving Office and claiming priority to Korean Patent Application Nos. 10-2022-0151857, filed on Nov. 14, 2022, and 10-2022-0175123, filed on Dec. 14, 2022, in the Korean Intellectual Property Office, the disclosures of each of which are incorporated by reference herein in their entireties.

### BACKGROUND

### Field

The disclosure relates to a method and electronic device for shifting a phase of a communication signal.

### Description of Related Art

With the development of wireless communication technology, electronic devices (e.g., electronic devices for communication) are being used widely in our daily lives, and an amount of data use due to this is increasing exponentially. Due to this rapid increase in a data use amount, a network capacity is gradually reaching a limit thereof, and after the commercialization of 4th generation (4G) communication systems, communication systems (e.g., 5th generation (5G), pre-5G communication systems, or new radio (NR)) that transmit and/or receive signals using a frequency of high frequency bands (e.g., mmWave band (e.g., above about 20 GHz), about 3 GHz to 300 GHz bands) are being studied to meet the increasing demand for wireless data traffic.

As a communication performance is improved, electronic devices are becoming capable of connecting communication with satellite devices located in space.

The above information may be provided as background technology for the purpose of assisting in understanding the disclosure. No assertion or determination is made as to whether any of the above contents is applicable as the prior art in connection with the disclosure.

Typically, electronic devices may be designed to support a linear polarization scheme, and satellite devices may be designed to support a circular polarization scheme. For example, in a process in which an electronic device (e.g., an electronic device supporting a linear polarization scheme) is connected in communication with a satellite device (e.g., a satellite device supporting a circular polarization scheme), an additional power loss of about 2-3 dB may occur. In a process in which a communication connection is established between devices with different communication signal schemes (e.g., an electronic device supporting a linear polarization scheme and a satellite device supporting a circular polarization scheme), an additional power loss may increase, and a communication performance may deteriorate.

An electronic device may include at least one antenna capable of transmitting and/or receiving a signal using a frequency of a high frequency band (e.g., mmWave band, about 3 GHz to 300 GHz band, ultra-high frequency band). The at least one antenna (e.g., antenna module) is being developed in an efficient mounting structure and various forms corresponding thereto for addressing a high free space loss and increasing a gain due to characteristics of the high frequency band. For example, the antenna may include an array antenna in which a various number of antenna elements (e.g., conductive patches and/or conductive patterns) are disposed at a regular interval in a dielectric structure (e.g., substrate).

An electronic device may include a wireless communication circuitry (e.g., radio frequency front end (RFFE)) for substantially simultaneously transmitting and/or receiving signals through a plurality of antenna elements included in an array antenna. The wireless communication circuitry may include a plurality of amplifier circuits (e.g., power amplifier (PA), a low noise amplifier (LNA)), and/or a plurality of frequency conversion devices (e.g., mixer and/or phase lock loop (PLL)) in order to transmit and/or receive signals through each antenna element.

An electronic device may include a plurality of antennas (e.g., first antenna, second antenna) that individually support a communication signal of a linear polarization scheme.

### SUMMARY

Embodiments of the disclosure provide a method of changing a first communication signal of a linear polarization scheme to a second communication signal of a circular polarization scheme by at least partially shifting a phase of the communication signal based on the plurality of antennas.

According to an example embodiment, an electronic device may include: a communication module including a first antenna and a second antenna, and configured to implement a communication signal of a circular polarization scheme based on the first antenna and the second antenna; a motion sensor; a memory; and at least one processor, comprising processing circuitry, operatively connected to the communication module, the motion sensor, and the memory, wherein at least one processor, individually and/or collectively, may be configured to cause the electronic device to: identify a first location of the electronic device through the communication; identify a second location of a first external electronic device connected in communication through the communication module based on satellite related information stored in the memory; calculate a relative direction with respect to the first external electronic device disposed at a second location using the electronic device disposed at the first location as a reference point; identify a state of the electronic device according to the calculated direction using the motion sensor; determine one of a first circular polarization scheme rotating along the first direction or a second circular polarization scheme rotating along the second direction opposite to the first direction based on the first antenna and the second antenna corresponding to the identified state of the electronic device; and generate a communication signal corresponding to the determined circular polarization scheme.

According to an example embodiment, a method of operating an electronic device may include: identifying a first location of an electronic device through a communication module including a first antenna and a second antenna; identifying a second location of a first external electronic device connected in communication through the communication module based on satellite related information stored in a memory; calculating a relative direction with respect to the first external electronic device disposed at the second location using the electronic device disposed at the first location as a reference point; identifying a state of the electronic device according to the calculated direction using a motion sensor; determining one of a first circular polarization scheme rotating along a first direction or a second circular polarization scheme rotating along a second direction opposite to the first direction based on the first antenna and the second antenna corresponding to the identified state of the electronic device; and generating a communication signal corresponding to the determined circular polarization scheme.

According to an example embodiment, a non-transitory computer-readable storage medium (or computer program product) storing one or more programs including instructions that, when executed by at least one processor, comprising processing circuitry, individually and/or collectively, of an electronic device, cause the electronic device to perform operations comprising: identifying a first location of the electronic device through a communication module including a first antenna and a second antenna; identifying a second location of a first external electronic device connected in communication through the communication module based on satellite related information stored in a memory; calculating a relative direction to the first external electronic device disposed at the second location using the electronic device disposed at the first location as a reference point; identifying a state of the electronic device according to the calculated direction using a motion sensor; determining one of a first circular polarization scheme rotating along a first direction or a second circular polarization scheme rotating along a second direction opposite to the first direction based on the first antenna and the second antenna corresponding to the identified state of the electronic device; and generating a communication signal corresponding to the determined circular polarization scheme.

According to various example embodiments, an electronic device can include a plurality of antennas (e.g., first antenna, second antenna), and change a communication signal of a linear polarization scheme to a communication signal of a circular polarization scheme using the plurality of antennas. For example, the electronic device can at least partially shift a phase of a communication signal corresponding to at least one of the first antenna or the second antenna, and change a first communication signal of a linear polarization scheme to a second communication signal of a circular polarization scheme. According to various embodiments, a satellite device located in space can generate a communication signal according to a circular polarization scheme (e.g., left revolving circular polarization scheme or right revolving circular polarization scheme).

According to various example embodiments, an electronic device and a satellite device can be connected in communication using a circular polarization scheme, and power consumption according to the communication connection can be relatively reduced. For example, first power consumption according to a communication connection between devices supporting the same communication scheme (e.g., circular polarization scheme) may be relatively less than second power consumption according to a communication connection between devices supporting different communication schemes (e.g., linear polarization scheme and circular polarization scheme). According to various example embodiments, as the communication scheme of the electronic device is changed from a linear polarization scheme to a circular polarization scheme, a communication performance according to the communication connection between the electronic device and the satellite device can be improved.

Effects that can be obtained from the disclosure are not limited to the above-described effects, and other effects not described will be clearly understood by one of ordinary skill in the art to which the disclosure belongs from the description below.

### BRIEF DESCRIPTION OF THE DRAWINGS

In connection with the description of the drawings, the same or similar reference numerals may be used for the same or similar components. Further, the above and other aspects, features and advantages of certain embodiments of the present disclosure will be more apparent from the following detailed description, taken in conjunction with the accompanying drawings, in which:

FIG. 1 is a block diagram illustrating an example electronic device within a network environment according to various embodiments;

FIG. 2 is a front perspective view of a front surface of an electronic device according to various embodiments;

FIG. 3 is a rear perspective view of an electronic device according to various embodiments;

FIG. 4 is a block diagram illustrating an example configuration of an electronic device according to various embodiments;

FIG. 5 is a flowchart illustrating an example method of shifting a phase of a communication signal according to various embodiments;

FIG. 6A is a diagram illustrating a communication circuit of a structure in which a communication signal is generated based on a plurality of antennas according to various embodiments;

FIG. 6B is a graph illustrating a process of implementing a communication signal of a circular polarization scheme based on a first antenna signal and a second antenna signal generated using the communication circuit of FIG. 6A according to various embodiments

FIG. 7A is a diagram illustrating an example scenario in which an electronic device is connected in communication with a satellite device based on a circular polarization scheme when the electronic device is in a first state (e.g., a state in which a front surface of the electronic device faces a satellite device) according to various embodiments; and

FIG. 7B is a diagram illustrating an example scenario in which an electronic device is connected in communication with a satellite device based on a circular polarization scheme when the electronic device is in a second state (e.g., a state in which a rear surface of the electronic device faces a satellite device) according to various embodiments.

### DETAILED DESCRIPTION

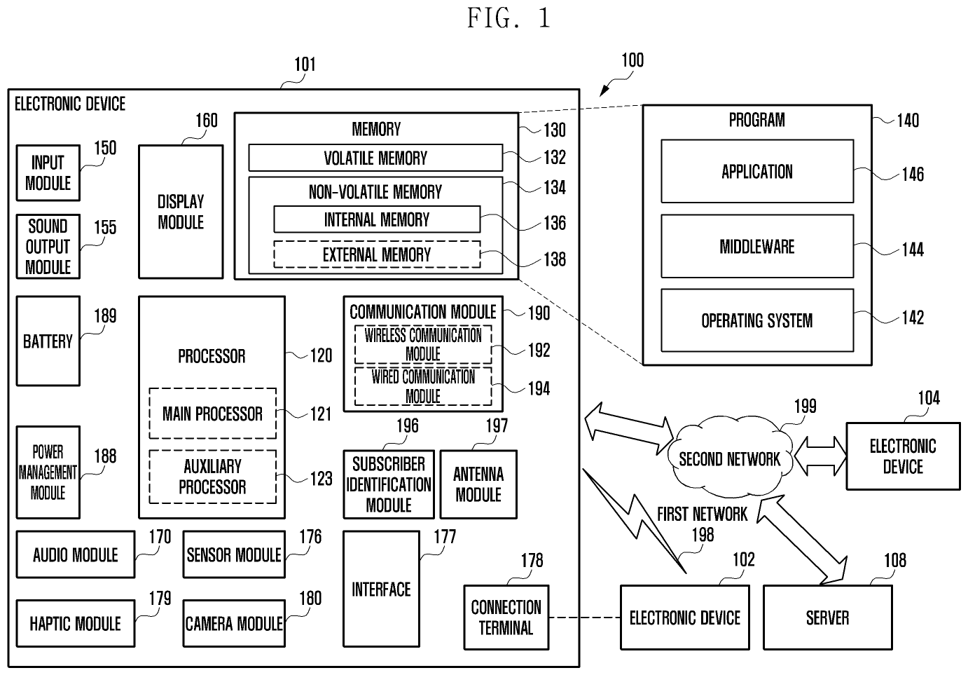

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) (e.g., a speaker or a headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). For example, the first antenna may transmit and/or receive a first antenna signal, based on a linear polarization scheme, along a first direction. The second antenna may transmit and/or receive a second antenna signal, based on a linear polarization scheme, along a second direction, different from the first direction. For example, the first antenna signal and the second antenna signal may be implemented as orthogonal to each other. If the first antenna signal is a communication signal corresponding to an x-axis direction, the second antenna signal may comprise a communication signal corresponding to a y-axis direction perpendicular to the x-axis direction.

According to various embodiments, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include a patch array antenna and/or a dipole array antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

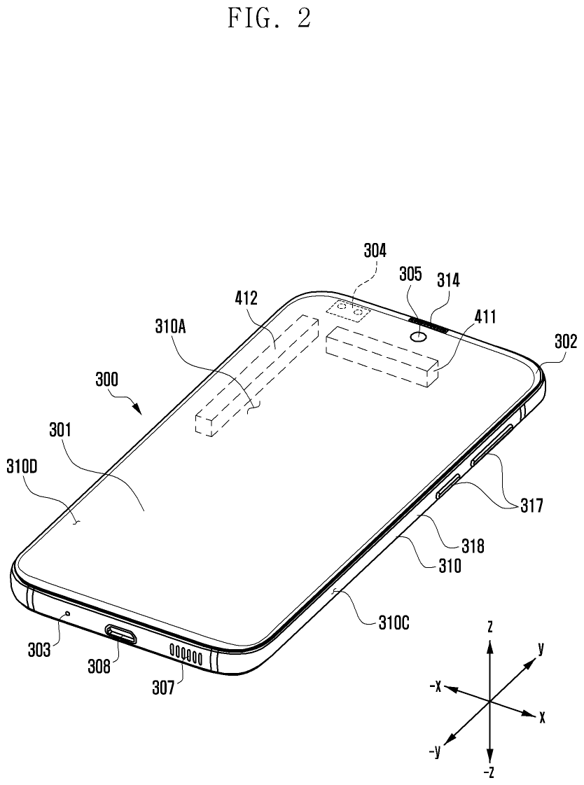

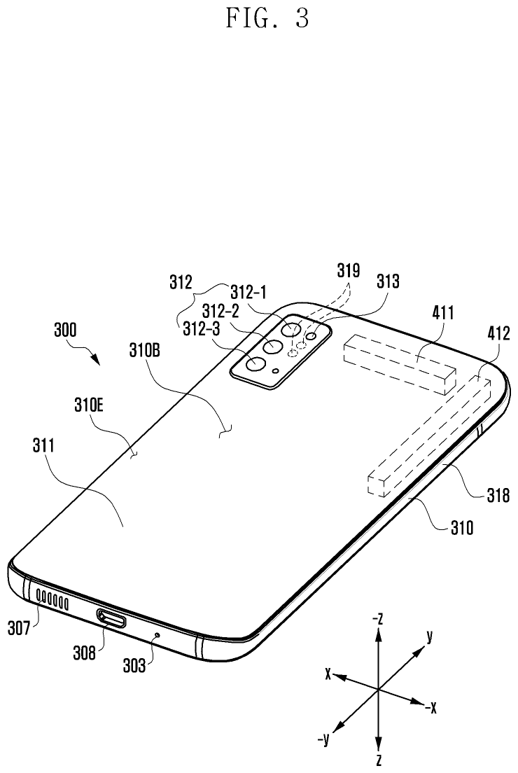

FIG. 2 is a front perspective of an electronic device 300 according to various embodiments. FIG. 3 is a rear perspective view of an electronic device 300 according to various embodiments.

According to an embodiment, the electronic device 300 of FIGS. 2 and 3 may be at least partially similar to the electronic device 101 of FIG. 1 or may include other components of the electronic device.

With reference to FIGS. 2 and 3, the electronic device 300 (e.g., the electronic device 101 of FIG. 1) according to an embodiment may include a housing 310 including a first surface (or front surface, front side) 310A, a second surface (or rear surface, rear side) 310B, and a side surface 310C enclosing a space (or internal space) between the first surface 310A and the second surface 310B. In an embodiment (not illustrated), the housing 310 may refer to a structure forming a portion of the first surface 310A, the second surface 310B, and the side surface 310C. According to an embodiment, the first surface 310A may be formed by a front plate 302 (e.g., a polymer plate or a glass plate including various coating layers) that is at least partially substantially transparent. The second surface 310B may be formed by a substantially opaque rear plate 311. The rear plate 311 may be formed by, for example, coated or colored glass, ceramic, a polymer, a metal (e.g., aluminum, stainless steel (STS), or magnesium), or a combination of at least two of the above-described materials. The side surface 310C may be formed by a side bezel structure (or “lateral member”) 318 coupled to the front plate 302 and the rear plate 311 and including a metal and/or a polymer. In various embodiments, the rear plate 311 and the side bezel structure 318 may be formed integrally and include the same material (e.g., a metal material such as aluminum).

According to an embodiment, the front plate 302 may include first regions 310D bent to be extended seamlessly from the first surface 310A toward the rear plate 311 at both long edges of the front plate 302. In the illustrated embodiment (see FIG. 3), the rear plate 311 may include second regions 310E bent to be extended seamlessly from the second surface 310B toward the front plate 302 at both long edges. In various embodiments, the front plate 302 (or the rear plate 311) may include only one of the first regions 310D (or the second regions 310E). In an embodiment, the front plate 302 (or the rear plate 311) may not include some of the first regions 310D (or the second regions 310E). In an embodiment, when viewed from the side surface of the electronic device 300, the side bezel structure 318 may have a first thickness (or width) at the side surface that does not include the first region 310D or the second region 310E, and have a second thickness thinner than the first thickness at the side surface that includes the first region 310D or the second region 310E.

According to an embodiment, the electronic device 300 may include at least one of a display 301 (e.g., the display module 160 of FIG. 1), an input device 303 (e.g., the input module 150 of FIG. 1), sound output devices 307 and 314 (e.g., the sound output module 155 of FIG. 1), sensor modules 304 and 319 (e.g., the sensor module 176 of FIG. 1), camera modules 305, 312, and 313 (e.g., the camera module 180 of FIG. 1), a key input device 317, an indicator (not illustrated) (e.g., the interface 177 of FIG. 1), or a connector hole 308 (e.g., the connection terminal 178 of FIG. 1). In various embodiments, the electronic device 300 may omit at least one (e.g., the key input device 317, the indicator, or the connector hole 308) of the components or may additionally include other components.

According to an embodiment, the display 301 may be visible through a significant portion of the front plate 302. In various embodiments, at least a portion of the display 301 may be visible through the front plate 302 forming the first surface 310A and the first region 310D of the side surface 310C. In various embodiments, the edge of the display 301 may be formed to be substantially the same as an adjacent outer shape of the front plate 302. In an embodiment (not illustrated), in order to expand an area in which the display 301 is visible, the gap between an outer edge of the display 301 and an outer edge of the front plate 302 may be formed to be substantially the same.

According to an embodiment, the display 301 may be coupled with or disposed adjacent to a touch sensing circuit, a pressure sensor capable of measuring the intensity (pressure) of a touch, and/or a digitizer capable of detecting a stylus pen of a magnetic field type. In various embodiments, at least a portion of the sensor modules 304 and 319, and/or at least a portion of the key input device 317, may be disposed in the first region 310D and/or the second region 310E.

According to an embodiment, the input device 303 may include a microphone 303. In various embodiments, the input device 303 may include a plurality of microphones 303 disposed to detect a direction of sound. The sound output devices 307 and 314 may include speakers 307 and 314. The speakers 307 and 314 may include an external speaker 307 and a call receiver 314. In various embodiments, the microphone 303, the speakers 307 and 314, and the connector 308 may be disposed in the space of the electronic device 300 and be exposed to an external environment through at least one hole formed in the housing 310. In various embodiments, the hole formed in the housing 310 may be used commonly for the microphone 303 and the speakers 307 and 314. In various embodiments, the sound output devices 307 and 314 may include a speaker (e.g., piezo speaker) operating without the hole formed in the housing 310.

According to an embodiment, the sensor modules 304 and 319 may generate electrical signals or data values corresponding to an internal operating state of the electronic device 300 or an external environmental state. The sensor modules 304 and 319 may include, for example, a first sensor module 304 (e.g., proximity sensor, optical sensor) and/or a second sensor module (not illustrated) (e.g., fingerprint sensor) disposed at the first surface 310A of the housing 310 and/or a third sensor module 319 (e.g., HRM sensor) disposed at the second surface 310B of the housing 310. The fingerprint sensor may be disposed at not only the first surface 310A (e.g., the display 301) of the housing 310 but also the second surface 310B. For example, the fingerprint sensor (e.g., ultrasonic or optical fingerprint sensor) may be disposed under the display 301 of the first surface 310A. The electronic device 300 may further include a sensor module not illustrated, for example, at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor 304.

According to an embodiment, the camera modules 305, 312, and 313 may include a first camera device 305 disposed at the first surface 310A of the electronic device 300, a second camera device 312 disposed at the second surface 310B, and/or a flash 313. The camera modules 305 and 312 may include one or more lenses, an image sensor, and/or an image signal processor. The flash 313 may include, for example, a light emitting diode or a xenon lamp. In various embodiments, two or more lenses (wide-angle lens and telephoto lens) and image sensors may be disposed at one surface of the electronic device 300.

According to an embodiment, the second camera device 312 may include fixed lens cameras 312-1 and 312-2 that performs a zoom function (e.g., digital zoom function) in a state in which a location of the lens is fixed. For example, the fixed lens cameras 312-1 and 312-2 may have a lens fixed at a location corresponding to a magnification of about 1×, and capture a first image corresponding to a magnification of about 1×. According to an embodiment, the electronic device 300 may perform a digital zoom function of at least partially cropping the first image and enlarging the cropped image when performing a zoom function exceeding a magnification of about 1× using the fixed lens cameras 312-1 and 312-2 (e.g., the second camera device 312).

According to an embodiment, the second camera device 312 may include a continuous optical zoom camera 312-3 that performs a zoom function according to a certain magnification range by physically moving at least one lens (e.g., zoom lens, auto focus (AF) lens). For example, the continuous optical zoom camera 312-3 may support a certain magnification range (e.g., from about 3× to about 5×) by physically moving at least one lens. According to an embodiment, the electronic device 300 may physically move the lens to a location corresponding to a specific magnification, thereby acquiring a high quality image through the continuous optical zoom camera 312-3.

According to an embodiment, the key input device 317 may be disposed at the side surface 310C of the housing 310. In an embodiment, the electronic device 300 may not include some or all of the key input devices 317, and the key input devices 317 that are not included may be implemented in the form of soft keys on the display 301. In various embodiments, the key input device 317 may be implemented using a pressure sensor included in the display 301.

According to an embodiment, the indicator (not illustrated) may be disposed at the first surface 310A of the housing 310. The indicator may provide, for example, state information of the electronic device 300 in the form of light. In an embodiment, the indicator may provide, for example, a light source linked to the operation of the camera module 305. The indicator may include, for example, a light emitting diode (LED), an infrared (IR) LED, and a xenon lamp.

According to an embodiment, the connector hole 308 may include a connector hole capable of receiving a connector (e.g., USB connector) for transmitting and receiving power and/or data to and from an external electronic device, and/or a connector hole (e.g., earphone jack) capable of receiving a connector for transmitting and receiving audio signals to and from an external electronic device.

According to an embodiment, the electronic device 300 may include a plurality of antennas (e.g., a first antenna 411 or a second antenna 412) for communicating with an external electronic device (e.g., the electronic devices 102 and 104 of FIG. 1, a satellite device). For example, the first antenna 411 and/or the second antenna 412 may be at least partially disposed in an internal space of the electronic device 300 and transmit and/or receive a communication signal. For example, the first antenna 411 and the second antenna 412 may be implemented in a rod-shaped form and each may transmit or receive a communication signal of a linear polarization scheme. For example, the linear polarization scheme may include a polarization scheme in which a vector direction of an electric field (e.g., electric field component) vibrates in a single one-dimensional direction. The linear polarization scheme may include a horizontal polarization scheme and a vertical polarization scheme that vibrates perpendicularly to a horizontally polarized wave. For example, a first antenna 411 that generates a first antenna signal according to a horizontal polarization scheme and a second antenna 412 that generates a second antenna signal according to a vertical polarization scheme may be disposed in the form orthogonal to each other. A polarization direction of the first antenna signal and a polarization direction of the second antenna signal may be orthogonal to each other.

According to an embodiment, the processor (e.g., the processor 120 of FIG. 1, communication processor (CP)) of the electronic device 300 may control the electronic device 300 to transmit or receive a first antenna signal according to a first direction (e.g., x-axis direction) based on the first antenna 411, and transmit or receive a second antenna signal according to a second direction (e.g., y-axis direction) based on the second antenna 412. Herein, where it is described that a “processor” performs a given function, it will be understood that at least one processor, comprising processing circuitry, individually and/or collectively, may be configured to cause the electronic device to perform the described function. For example, the first antenna signal and the second antenna signal may be communication signals having linear polarization. According to an embodiment, the processor 120 may shift a phase of at least one of the first antenna signal or the second antenna signal. For example, the processor 120 may shift a phase of the first antenna signal and the second antenna signal to be different by about 90 degrees or about 270 degrees relative to each other. According to an embodiment, the first antenna signal and the second antenna signal may be communication signal of a linear polarization scheme having a phase difference of about 90 degrees or about 270 degrees with respect to each other. For example, in the case that the first antenna signal and the second antenna signal corresponding to a linear polarization scheme are radiated along substantially the same direction, the communication signal of a linear polarization scheme based on the first antenna signal and the second antenna signal may be converted into a communication signal of a circular polarization scheme.

According to an embodiment, the circular polarization scheme may include a left revolving circular polarization scheme that revolves along the left direction and a right revolving circular polarization scheme that revolves along the right direction. For example, a communication signal according to the circular polarization scheme may be determined to one of the left revolving circular polarization scheme and the right revolving circular polarization scheme based on a difference value between a phase of a first antenna signal and a phase of a second antenna signal. In an embodiment, the processor 120 may adjust a magnitude in which the phase is shifted, thereby changing a communication signal of the circular polarization scheme into one of the left revolving circular polarization scheme and/or the right revolving circular polarization scheme.

According to an embodiment, the electronic device 300 may be connected in communication with a satellite device (e.g., external electronic device). For example, in the case that the satellite device supports a communication signal according to a right revolving circular polarization scheme, the electronic device 300 may transmit a communication signal of a left revolving circular polarization scheme toward a location of the satellite device. For another example, in the case that the satellite device supports a communication signal according to a left revolving circular polarization scheme, the electronic device 300 may transmit a communication signal of a right revolving circular polarization scheme toward the location of the satellite device. According to an embodiment, in a situation in which the electronic device 300 is connected in communication with the satellite device, the electronic device 300 may identify a circular polarization scheme supported by the satellite device among circular polarization schemes (e.g., left revolving circular polarization scheme or right revolving circular polarization scheme) and generate a communication signal based on a circular polarization scheme different from the identified circular polarization scheme. The electronic device 300 may transmit a communication signal generated based on the circular polarization scheme toward the location of the satellite device, thereby being operatively connected in communication with the satellite device.

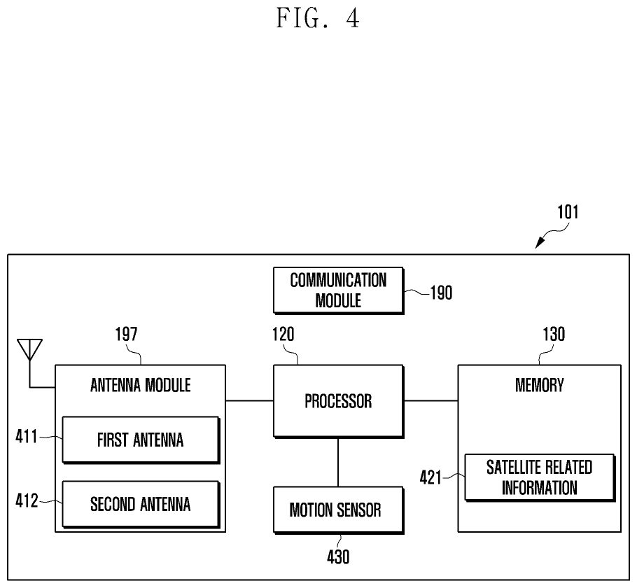

FIG. 4 is a block diagram illustrating an example configuration of an electronic device according to various embodiments.

The electronic device 101 of FIG. 4 may be at least partially similar to the electronic device 101 of FIG. 1, the electronic device 300 of FIG. 2, and the electronic device 300 of FIG. 3, or may further include other components of the electronic device 101.

A first antenna 411 of FIG. 4 may include the first antenna 411 illustrated in FIGS. 2 and 3, and a second antenna 412 may include the second antenna 412 illustrated in FIGS. 2 and 3. According to an embodiment, the first antenna 411 and the second antenna 412 may not have a specific disposition form but may be disposed in the form orthogonal to each other.

With reference to FIG. 4, the electronic device (e.g., the electronic device 101 of FIG. 1) may include a processor (e.g., the processor 120 of FIG. 1 including processing circuitry), a memory (e.g., the memory 130 of FIG. 1), a communication module (e.g., the communication module 190 of FIG. 1 including communication circuitry), an antenna module (e.g., the antenna module 197 of FIG. 1 including at least one antenna), and/or a motion sensor (e.g., the sensor module 176 of FIG. 1). For example, satellite related information 421 may be stored in the memory 130. The antenna module 197 may include a first antenna 411 and a second antenna 412 supporting linear polarization schemes of different vector directions. For example, the first antenna 411 may generate a first communication signal according to a horizontal polarization direction, and the second antenna 412 may generate a second communication signal according to a vertical polarization direction.

According to an embodiment, the processor 120 of the electronic device 101 may include various processing circuitry and execute a program (e.g., the program 140 of FIG. 1) stored in the memory 130 to control other components (e.g., hardware and/or software components) of the electronic device 101 and/or the external electronic device 201, and perform various data processing and/or operations. According to an embodiment, the processor 120 may be operatively, functionally, and/or electrically connected to the memory 130, the communication module 190, the antenna module 197, and/or a motion sensor 430.

According to an embodiment, the processor 120 may include a communication processor (CP) included in the auxiliary processor 123 of FIG. 1. For example, the processor 120 may be implemented into various components of the communication module 190 and control at least a part of functions or states related to the communication module 190. Thus, it will be understood that the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the memory 130 may store satellite related information 421. For example, the satellite related information 421 may include at least one of direction information, location information, trajectory information, communication signal related information, information on a generated communication signal, and/or information on a polarization scheme of a communication signal related to at least one satellite device located in space. For example, the information on the communication signal may include at least one of a transmission direction, a transmission speed, and/or a polarization scheme (e.g., linear polarization scheme, or circular polarization scheme (e.g., left revolving circular polarization scheme, or right revolving circular polarization scheme)) of a communication signal generated by the satellite device. For example, the satellite related information 421 may include information related to a satellite device corresponding to each of a plurality of satellite devices located in space, and be stored in the memory 130 in the form of a look-up table.

According to an embodiment, the processor 120 may identify a satellite device operatively connected in communication, and identify satellite related information 421 corresponding to the identified satellite device based on satellite related information 421 stored in the memory 130. The processor 120 may identify a relative location (e.g., second location) of the satellite device and a relative angle of the satellite device based on a location (e.g., first location) of the electronic device 101 based on the identified satellite related information 421. The processor 120 may identify a polarization scheme supported by the satellite device based on the identified satellite related information 421.

According to an embodiment, the communication module 190 may include various communication circuitry and perform a communication connection between the electronic device 101 and the satellite device (e.g., external electronic device). For example, the communication module 190 may include one or more communication processors (CPs) that support direct (e.g., wired) communication or wireless communication. According to an embodiment, the processor 120 may function as a communication processor. The processor 120 may establish a communication channel through the communication module 190 so that the electronic device 101 and the satellite device may be operatively connected to each other in communication, and perform wireless communication through the established communication channel.

According to an embodiment, the antenna module 197 may include at least one antenna and transmit communication signals or power to an external electronic device (e.g., satellite device), or receive communication signals or power from the external electronic device. According to an embodiment, the antenna module 197 may include an antenna including a radiator formed with a conductor or a conductive pattern formed on a substrate (e.g., PCB). According to an embodiment, the antenna module 197 may include a plurality of antennas (e.g., array antenna).

With reference to FIG. 4, the antenna module 197 may include a first antenna 411 and a second antenna 412 that generate a communication signal based on a linear polarization scheme. For example, the first antenna 411 and the second antenna 412 may include array antennas arranged in a parallel shape, as in a rod shape. According to an embodiment, the first antenna 411 may be implemented in the form in which at least one antenna element is arranged along a first direction (e.g., x-axis direction), as in the first antenna 411 of FIG. 2. The processor 120 may generate a first antenna signal in which a vector direction of an electric field (e.g., electric field component) vibrates along the first direction (e.g., x-axis direction) based on the first antenna 411. According to an embodiment, the second antenna 412 may be implemented in the form in which at least one antenna element is arranged along a second direction (e.g., y-axis direction), as in the second antenna 412 of FIG. 2. The processor 120 may generate a second antenna signal in which a vector direction of an electric field (e.g., electric field component) vibrates along the second direction (e.g., y-axis direction) based on the second antenna 412.

With reference to FIG. 4, the vibration direction (e.g., x-axis direction) of the first antenna signal and the vibration direction (e.g., y-axis direction) of the second antenna signal may be perpendicular to each other. For example, the first antenna signal may include a communication signal of a horizontal polarization scheme that vibrates horizontally (e.g., horizontal direction, x-axis direction) based on a horizontal line, and the second antenna signal may include a communication signal of a vertical polarization scheme that vibrates vertically (e.g., vertical direction, y-axis direction) based on a horizontal line. According to an embodiment, the first antenna signal corresponding to the first antenna 411 and the second antenna signal corresponding to the second antenna 412 may be communication signals orthogonal to each other. The polarization direction of the first antenna signal and the polarization direction of the second antenna signal may be orthogonal to each other.

According to an embodiment, the processor 120 may select one of the first antenna 411 and the second antenna 412 and generate a communication signal of a linear polarization scheme using the selected one antenna. According to an embodiment, in the case that the first antenna signal and the second antenna signal are generated together based on the first antenna 411 and the second antenna 412, the processor 120 may generate a communication signal of a circular polarization scheme.

According to an embodiment, the processor 120 may shift the phase of at least one of the first antenna signal or the second antenna signal. For example, the processor 120 may shift the phase of the first antenna signal and the second antenna signal to be relatively different by about 90 degrees or about 270 degrees. According to an embodiment, the first antenna signal and the second antenna signal may include communication signal of a linear polarization scheme having different phases from each other. For example, in the case that the first antenna signal and the second antenna signal are radiated along substantially the same direction, a communication signal of a linear polarization scheme based on the first antenna signal and the second antenna signal may be converted into a communication signal of a circular polarization scheme. For example, the processor 120 may generate one circularly polarized signal among a right revolving circularly polarized signal and a left revolving circularly polarized signal. In the following embodiments, the right revolving circularly polarized signal may include a signal that rotates clockwise based on the electronic device 101. The left revolving circularly polarized signal may include a signal that rotates counterclockwise based on the electronic device 101.

According to an embodiment, the motion sensor 430 may identify a direction, posture, location, and/or state of the electronic device 101. For example, the motion sensor 411 may include at least one of a proximity sensor, an acceleration sensor, and/or a gyro sensor. For example, the processor 120 may identify whether the user is holding the electronic device 101 or whether the user is holding the electronic device 101 and moving, and the like, using the motion sensor 430. For example, the processor 120 may identify whether the front surface (e.g., the first surface 310A of FIG. 2) of the electronic device 101 is disposed facing the location of the satellite device, or whether the rear surface (e.g., the second surface 310B of FIG. 3) of the electronic device 101 is disposed facing the location of the satellite device. For example, the processor 120 may identify whether the electronic device 101 is in a state of a horizontal mode (e.g., a state in which the second antenna 412 of FIG. 2 is disposed parallel to the horizontal line) or a state of a vertical mode (e.g., a state in which the first antenna 411 of FIG. 2 is disposed parallel to the horizontal line). According to an embodiment, the electronic device 101 may identify a relative state of the electronic device 101 based on a location of the satellite device using the motion sensor 430. For example, the processor 120 may identify whether the front surface 310A of the electronic device 101 is facing the satellite device or whether the rear surface 310B of the electronic device 101 is facing the satellite device.

According to an embodiment, when the front surface 310A of the electronic device 101 faces the satellite device, the processor 120 may transmit a communication signal along the direction of the front surface 310A and be operatively connected in communication to the satellite device. According to an embodiment, when the rear surface 310B of the electronic device 101 faces the satellite device, the processor 120 may transmit a communication signal along the direction of the rear surface 310B and be operatively connected in communication to the satellite device. According to an embodiment, the electronic device 101 may generate a communication signal of a circular polarization scheme different from a circular polarization scheme (e.g., right revolving circular polarization scheme or left revolving circular polarization scheme) supported by the satellite device, and establish a communication connection with the satellite device based on the communication signal generated according to the circular polarization scheme.

According to an embodiment, the electronic device (e.g., the electronic device 101 of FIG. 1, the electronic device 300 of FIGS. 2 and 3, and/or the electronic device 101 of FIG. 4) may include a first antenna (e.g., the first antenna 411 of FIG. 4) and a second antenna (e.g., the second antenna 412 of FIG. 4), and a communication module (e.g., the communication module 190 of FIG. 4) that implements a communication signal of a circular polarization scheme based on the first antenna 411 and the second antenna 412. The electronic device 101 may include a motion sensor (e.g., the motion sensor 430 of FIG. 4), a memory (e.g., the memory 130 of FIG. 4), and a processor 120 operatively connected to the communication module 190, the motion sensor 430, and the memory 130. The processor 120 may identify a first location of the electronic device 101 through the communication module 190. The processor 120 may identify a second location of the first external electronic device connected in communication through the communication module 190 based on the satellite related information 421 stored in the memory 130. The processor 120 may calculate a relative direction to the first external electronic device disposed at the second location using the electronic device 101 disposed at the first location as a reference point. The processor 120 may identify a state of the electronic device 101 according to the calculated direction using the motion sensor 430. The processor 120 may determine one of a first circular polarization scheme (e.g., right revolving circular polarization scheme) that rotates along a first direction or a second circular polarization scheme (e.g., left revolving circular polarization scheme) that rotates along a second direction, which is a direction opposite to the first direction based on the first antenna 411 and the second antenna 412 corresponding to the identified state of the electronic device 101. The processor 120 may generate a communication signal corresponding to the determined circular polarization scheme.

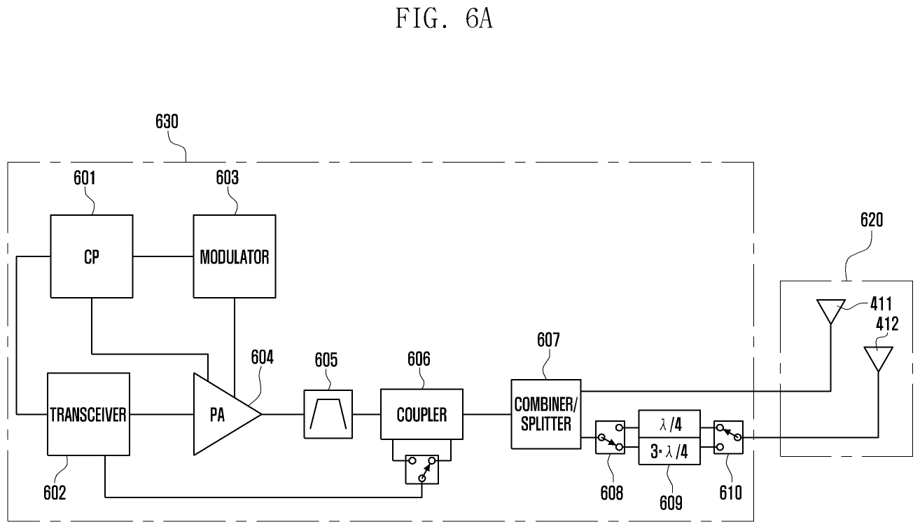

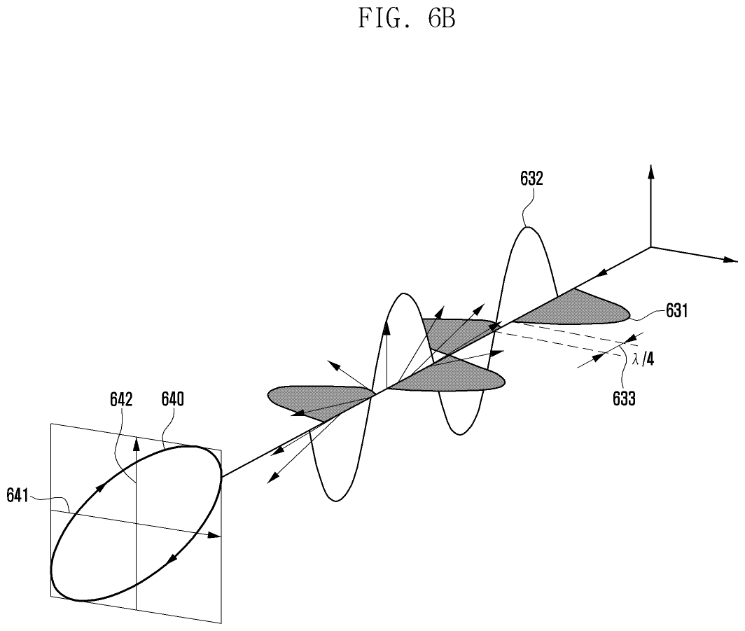

The electronic device 101 according to an embodiment may further include a phase shifter 609 (e.g., refer to FIG. 6A) connected to the second antenna 412. The processor 120 may shift a phase of a second antenna signal transmitted to the second antenna 412 using the phase shifter 609. The processor 120 may generate a communication signal corresponding to a circular polarization scheme based on a first antenna signal corresponding to the first antenna 411 and a second antenna signal corresponding to the second antenna 412 and whose phase is shifted.

According to an embodiment, the processor 120 may shift the phase of the second antenna signal so that the phase difference occurs by about 90 degrees or about 270 degrees based on the first antenna signal using the phase shifter 609.

According to an embodiment, the processor 120 may determine one of a first circular polarization scheme (e.g., right revolving circular polarization scheme) and a second circular polarization scheme (e.g., left revolving circular polarization scheme) based on a phase difference value between the first antenna signal and the second antenna signal. The processor 120 may generate a communication signal corresponding to the determined circular polarization scheme.

According to an embodiment, the processor 120 may identify a circular polarization scheme supported by the first external electronic device. In the case that the identified circular polarization scheme is the first circular polarization scheme, the processor 120 may shift the phase of a second antenna signal transmitted to the second antenna 412 using the phase shifter 609 so that a communication signal corresponding to a second circular polarization scheme different from the first circular polarization scheme is generated.

According to an embodiment, the processor 120 may identify a first state in which the first surface 310A of the electronic device 101 faces the first external electronic device using the motion sensor 430. The processor 120 may generate a communication signal of a circular polarization scheme along a direction toward the first external electronic device through the first surface 310A.

According to an embodiment, the processor 120 may identify a second state in which the second surface 310B of the electronic device 101 faces the first external electronic device using the motion sensor 430. The processor 120 may generate a communication signal of a circular polarization scheme along a direction toward the first external electronic device through the second surface 310B.

According to an embodiment, the motion sensor 430 may include at least one of a proximity sensor, an acceleration sensor, or a gyro sensor.

According to an embodiment, the satellite related information 421 may include at least one of direction information, location information, trajectory information, communication signal related information, information on supporting communication signals, or information on a polarization scheme of communication signals, related to at least one satellite device located in space. The first external electronic device may include at least one satellite device.

According to an embodiment, the first antenna 411 and the second antenna 412 may each transmit or receive a communication signal of a linear polarization scheme. According to an embodiment, a first polarization direction of the first antenna signal corresponding to the first antenna 411 and a second polarization direction of the second antenna signal corresponding to the second antenna 412 may be orthogonal to each other.

According to an embodiment, the processor 120 may acquire GPS information from a GPS satellite device connected through the communication module 190. The processor 120 may identify a first location of the electronic device 101 based on the acquired GPS information.

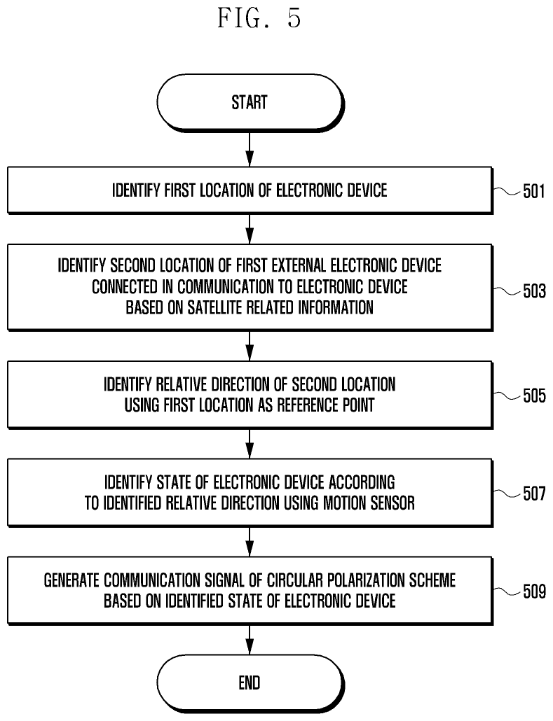

FIG. 5 is a flowchart illustrating an example method of shifting a phase of a communication signal according to various embodiments.

In the following, the respective operations may be performed sequentially, but are not necessarily performed sequentially. For example, the order of the respective operations may be changed, and at least two operations may be performed in parallel.

The electronic device 101 of FIG. 5 may be at least partially similar to the electronic device 101 of FIG. 1, the electronic device 300 of FIGS. 2 and 3, or may further include other components of the electronic device 101.

According to an embodiment, the electronic device 101 may be in a state of being connected in communication with at least one global positioning system (GPS) satellite device through a communication module (e.g., the communication module 190 of FIG. 4) and receive a GPS signal from the at least one GPS satellite device. The processor (e.g., the processor 120 of FIG. 4) of the electronic device 101 may identify a current location (e.g., first location, coordinate information) of the electronic device 101 based on the received GPS signal. According to an embodiment, the processor 120 may be in a state of being connected in communication with the satellite device (e.g., first external electronic device, first satellite device) through the communication module 190. For example, the processor 120 may be in a state of transmitting and/or receiving a communication signal (e.g., data) to and from the satellite device through the communication module 190. For example, the electronic device 101 may be connected in communication to the satellite device using an antenna module (e.g., the antenna module 197 of FIG. 4, the first antenna 411 of FIG. 4, or the second antenna 412 of FIG. 4) supporting a linear polarization scheme.

The processor 120 may identify a first satellite device to which the communication is connected, and identify information (e.g., a location of the satellite device, trajectory information of the satellite device, or communication related information of the satellite device) corresponding to the identified first satellite device based on satellite related information 421 stored in the memory (e.g., the memory 130 of FIG. 4). The processor 120 may identify a current location (e.g., second location, trajectory information) of the first satellite device based on the satellite related information 421. The processor 120 may identify a relative direction, angle, or location of the first satellite device based on the first location of the electronic device 101 and the second location of the first satellite device. The electronic device 101 may identify a state (e.g., posture, position, location) of the electronic device 101 using a motion sensor (e.g., the motion sensor 430 of FIG. 4). According to an embodiment, the processor 120 may transmit or receive a communication signal of a circular polarization scheme based on the second location of the first satellite device and the state of the electronic device 101.

For example, the electronic device 101 may include a plurality of antennas (e.g., the first antenna 411 or the second antenna 412) for communicating with the first satellite device. For example, the first antenna 411 and the second antenna 412 may each transmit or receive a communication signal of a linear polarization scheme. For example, the first antenna 411 may transmit a communication signal of a horizontal polarization scheme (e.g., first antenna signal, horizontally polarized signal) in which a propagation direction of the electromagnetic wave vibrates parallelly based on a horizontal line, and the second antenna 412 may generate a communication signal of a vertical polarization scheme (e.g., second antenna signal, vertically polarized signal) in which a propagation direction of the electromagnetic wave vibrates vertically based on the horizontal line. For example, the first antenna 411 and the second antenna 412 may be disposed in the form orthogonal to each other. For example, a polarization direction (e.g., horizontal polarization) of the first antenna signal transmitted through the first antenna 411 and a polarization direction (e.g., vertical polarization) of the second antenna signal transmitted through the second antenna 412 may be orthogonal to each other. According to an embodiment, the electronic device 101 may at least partially shift a phase of at least one of the first antenna signal or the second antenna signal, and generate a communication signal corresponding to a circular polarization scheme based on the first antenna 411 and the second antenna 412. The electronic device 101 may transmit a communication signal of a circular polarization scheme toward a second location of the first satellite device, and establish a communication connection with the first satellite device.

With reference to FIG. 5, in operation 501, the processor 120 may identify a first location (e.g., current location) of the electronic device 101. For example, the processor 120 may identify a first location of the electronic device 101 using a GPS signal received from a GPS satellite device, or may identify a first location of the electronic device 101 using information on an adjacent base station connected to the electronic device 101. The method of identifying the first location is not limited to a specific method.

In operation 503, the processor 120 may identify a second location of a first external electronic device (e.g., first satellite device) connected in communication to the electronic device 101 based on satellite related information 421 stored in the memory 130. For example, the electronic device 101 may be in a state connected in communication to the first external electronic device through the communication module 190, and identify index information, a kind, and/or a type of the first external electronic device based on a communication signal received from the first external electronic device. The processor 120 may acquire location information related to the first external electronic device based on the satellite related information 421.

In operation 505, the processor 120 may identify a relative direction of a second location (e.g., second coordinate information) using a first location (e.g., first coordinate information) as a reference point. For example, the processor 120 may identify a direction, angle, or distance corresponding to the second location based on the first location.

In operation 507, the processor 120 may identify a state of the electronic device 101 according to the identified relative direction (e.g., the direction corresponding to the second location) using the motion sensor 430. For example, the motion sensor 430 may include at least one of a proximity sensor, an acceleration sensor, and/or a gyro sensor. The motion sensor 430 may identify a direction, a posture, a location, and/or a state of the electronic device 101. In operation 507, the processor 120 may identify whether a front surface (e.g., the first surface 310A of FIG. 2) of the electronic device 101 is in a state disposed facing a second location of the satellite device, or whether a rear surface (e.g., the second surface 310B of FIG. 3) of the electronic device 101 is in a state disposed facing a second location of the satellite device. For example, the processor 120 may determine a direction in which a communication signal is transmitted (e.g., the direction toward the front surface or the rear surface of the electronic device 101) based on the state of the electronic device 101.

In operation 509, the processor 120 may generate a communication signal of a circular polarization scheme based on the identified state of the electronic device 101. For example, if the front surface of the electronic device 101 is in a state facing the second location, the processor 120 may transmit a communication signal generated based on a circular polarization scheme toward the satellite device while passing through the front surface of the electronic device 101. According to an embodiment, the electronic device 101 may include a first antenna 411 and a second antenna 412 supporting a linear polarization scheme. For example, the first antenna 411 may transmit a horizontal polarization scheme communication signal (e.g., first antenna signal) in which a propagation direction of an electromagnetic wave vibrates parallelly based on a horizontal line, and the second antenna 412 may transmit a vertical polarization scheme communication signal (e.g., second antenna signal) in which a propagation direction of an electromagnetic wave vibrates vertically based on a horizontal line. The first antenna 411 and the second antenna 412 may be disposed orthogonally to each other. According to an embodiment, the electronic device 101 may at least partially shift the phases of the first antenna signal and the second antenna signal, and generate a communication signal of a circular polarization scheme based on the first antenna 411 and the second antenna 412. For example, the circular polarization scheme may be classified into a left revolving circular polarization scheme and a right revolving circular polarization scheme based on the direction in which the communication signal rotates. The processor 120 may identify a circular polarization scheme supported by the satellite device (e.g., the first external electronic device) based on satellite related information 421, and shift the phases of the first antenna signal and the second antenna signal so as to generate a communication signal of a circular polarization scheme different from the identified circular polarization scheme. In operation 509, the processor 120 may transmit a communication signal of a circular polarization scheme based on the direction toward the second location of the first external electronic device.

According to an embodiment, the electronic device 101 may identify a first location thereof and a second location of the first external electronic device (e.g., satellite device), and identify a relative direction of the second location based on the first location. The electronic device 101 may identify a circular polarization scheme supported by the first external electronic device based on satellite related information 421, and generate a communication signal of a circular polarization scheme different from the identified circular polarization scheme. The electronic device 101 may identify a state thereof, and transmit the generated communication signal of the circular polarization scheme along a direction toward the first external electronic device.

FIG. 6A is a diagram illustrating an example communication circuit having a configuration in which a communication signal is generated based on a plurality of antennas according to various embodiments.

The electronic device 101 of FIG. 6A may be at least partially similar to the electronic device 101 of FIG. 1, the electronic device 300 of FIGS. 2 and 3, or may further include other components of the electronic device 101. A communication circuit 630 of FIG. 6A may be included in a communication module (e.g., the communication module 190 of FIG. 4) and illustrates an electrical connection structure with an antenna module 620 (e.g., the antenna module 197, the first antenna 411, the second antenna 412 of FIG. 4).

With reference to FIG. 6A, a processor (e.g., the processor 120 of FIG. 4) of the electronic device 101 may transmit a communication signal generated through the communication circuit 630 to the antenna module 620 and at least partially shift a phase of the communication signal through the antenna module 620. The processor 120 may transmit together a first antenna signal corresponding to a first antenna (e.g., the first antenna 411 of FIG. 4) and a second antenna signal corresponding to a second antenna (e.g., the second antenna 412 of FIG. 4)), thereby transmitting a communication signal of a circular polarization scheme. In an embodiment, the processor 120 may select one of a right revolving circular polarization scheme or a left revolving circular polarization scheme based on a phase difference between the first antenna signal and the second antenna signal, and transmit a communication signal according to the selected circular polarization scheme.

With reference to FIG. 6A, the communication circuit 630 may include a communication processor (CP) (e.g., including processing circuitry) 601, a transceiver (TRCV) 602, a modulator 603, a power amplifier (PA) 604, a filter 605, a coupler 606, a combiner/splitter 607, a phase shifter 609, and/or at least one switch 608 and 610.

The CP 601 may include various processing circuitry and control communication and processing of digital signals. For example, the CP 601 is in a state electrically connected to the transceiver 602, the modulator 603, and the power amplifier 604, and may at least partially control the operation of each component. For example, the CP 601 may include a protocol stack for performing operations within layers defined in a communication specification. The CP 601 may generate and interpret messages according to a format defined in a communication specification, and interact with a network based on the messages. For example, the CP 601 may perform channel encoding or decoding, and modulation or demodulation, and process digital/baseband signals. With reference to FIG. 6A, the CP 601 may transmit a control signal to the transceiver 602 so that a radio frequency signal (RF signal) is transmitted to the power amplifier 604 through the transceiver 602. The CP 601 may transmit a control signal to the modulator 603 so that a configured voltage Vcc is supplied to the power amplifier 604 through the modulator 603. The CP 601 may transmit a control signal for at least partially controlling the power amplifier 604 to the power amplifier 604.

The transceiver 602 may perform processing for transmitting or receiving a signal (e.g., RF signal). For example, the transceiver 602 may perform frequency band conversion and/or amplification of the signal. The transceiver 602 may process an analog/intermediate (IF) signal or an RF signal. The transceiver 602 may include a digital to analog converter (DAC), an analog to digital converter (ADC), a mixer, and/or an oscillator.

The modulator 603 may supply power to the power amplifier 604 and generate a modulated power signal. For example, the modulator 603 may perform a function such as a modulator that performs a modulation operation. The modulator 603 may at least partially supply power to the power amplifier 604 so that the power amplifier 604 may be driven.

With reference to FIG. 6A, the communication circuit 630 may amplify an RF signal generated in the transceiver 602 through the power amplifier 604, and control the RF signal to be transmitted to the combiner/splitter 607 through the filter 605 and the coupler 606. For example, the filter 605 may filter the RF signal according to a frequency band of a signal (e.g., RF signal) used for communication. The coupler 606 may couple the RF signal filtered by the filter 605. The RF signal coupled through the coupler 606 may be transmitted to the combiner/splitter 607. For example, the combiner/splitter 607 may perform a function of combining a plurality of communication signals into a single communication signal, or distributing a single communication signal into a plurality of communication signals.

With reference to FIG. 6A, the combiner/splitter 607 may be connected to the antenna module 620 (e.g., the first antenna 411 and/or the second antenna 412) without through a phase shifter, or may be connected to the antenna module 620 through the phase shifter 609 and at least one switch 608 and 610. The phase shifter 609 may perform a function of at least partially shifting a phase of a communication signal. For example, the first antenna 411 connected to the combiner/splitter 607 without through the phase shifter 609 may generate a first antenna signal based on a first phase. For another example, in a state in which the phase shifter 609 is disposed between the combiner/splitter 607 and the second antenna 412, the second antenna 412 connected to the phase shifter 609 may generate a second antenna signal based on a second phase. A first antenna signal generated through the first antenna 411 and a second antenna signal generated through the second antenna 412 may have a phase difference (e.g., about ±90 degrees (e.g., λ/4), about ±270 degrees (e.g., 3*λ/4)) with each other. According to an embodiment, the CP 601 may generate a first antenna signal and a second antenna signal having different phases based on the combiner/splitter 607 and the phase shifter 609. The CP 601 may transmit a first antenna signal through the first antenna 411 and a second antenna signal through the second antenna 412.

According to an embodiment, the antenna module 620 may include a first antenna 411 and a second antenna 412 that generate a communication signal based on a linear polarization scheme. The CP 601 may generate a first antenna signal in which a vector direction of an electric field (e.g., electric field component) vibrates along a first direction (e.g., x-axis direction) based on the first antenna 411. The CP 601 may generate a second antenna signal in which a vector direction of an electric field (e.g., electric field component) vibrates along a second direction (e.g., y-axis direction) based on the second antenna 412. For example, the first antenna signal may include a horizontal polarization signal that vibrates horizontally (e.g., in the x-axis direction) based on a horizontal line, and the second antenna signal may include a vertical polarization signal that vibrates vertically (e.g., in the y-axis direction) based on the horizontal line. For example, a horizontal polarization signal corresponding to the first antenna signal and a vertical polarization signal corresponding to the second antenna signal may be orthogonal to each other. According to an embodiment, when the first antenna signal and the second antenna signal are transmitted in substantially the same direction, the electronic device 101 may generate a circular polarization signal based on the first antenna signal and the second antenna signal.

With reference to FIG. 6A, the CP 601 may transmit a signal of a first phase to the first antenna 411 through the combiner/splitter 607 and generate a first antenna signal through the first antenna 411. The CP 601 may transmit the signal of the first phase to the phase shifter 609 through the combiner/splitter 607 and shift the signal of the first phase into a signal of the second phase through the phase shifter 609. The CP 601 may transmit the signal of the second phase to the second antenna 412 and generate a second antenna signal through the second antenna 412. For example, the phase shifter 609 may at least partially shift a phase of a signal supplied to the second antenna 412. For example, the signal of the first phase distributed from the combiner/splitter 607 may be shifted into a signal of the second phase through the phase shifter 609. For example, the phase shifter 609 may shift the phase of the communication signal to be different by about ±90 degrees (e.g., λ/4), or may shift the phase of the communication signal to be different by about ±270 degrees (e.g., 3*λ/4).

According to an embodiment, a communication signal according to a right revolving circular polarization scheme or a communication signal according to a left revolving circular polarization scheme may be generated based on a phase difference between the first antenna signal and the second antenna signal.

According to an embodiment, the electronic device 101 may identify a circular polarization scheme corresponding to a communication signal transmitted from a first external electronic device (e.g., satellite device), and generate a communication signal of a circular polarization scheme different from the identified circular polarization scheme. For example, in the case that the communication signal transmitted from the first external electronic device is a communication signal according to a right revolving circular polarization scheme, the electronic device 101 may generate a communication signal according to a left revolving circular polarization scheme through the antenna module 620. The electronic device 101 may establish a communication connection with the first external electronic device based on the left revolving circular polarization scheme.

According to an embodiment, the electronic device 101 may change a communication scheme (e.g., linear polarization scheme, circular polarization scheme) according to at least one communication signal using the phase shifter 609. For example, the electronic device 101 may include a first antenna that generates a first antenna signal according to a first direction based on the linear polarization scheme and a second antenna that generates a second antenna signal according to a second direction different from the first direction. The electronic device 101 may transmit or receive a communication signal of a linear polarization scheme according to a specific direction using one of the first antenna and the second antenna. According to an embodiment, the electronic device 101 may shift a phase of at least one of a first antenna signal corresponding to the first direction and/or a second antenna signal corresponding to the second direction using the phase shifter 609. For example, the first antenna signal may be transmitted or received corresponding to a first direction, and the second antenna signal may be transmitted or received corresponding to a second direction perpendicular to the first direction. For example, the electronic device 101 may shift a phase of the second antenna signal such that a phase of the second antenna signal differs by about 90 degrees or about 270 degrees relative to a phase of the first antenna signal, and generate a communication signal corresponding to a circular polarization scheme based on the first antenna signal and the second antenna signal whose phase is shifted. The electronic device 101 may determine one of a left revolving circular polarization scheme and a right revolving circular polarization scheme based on a phase difference value, and generate a communication signal corresponding to the determined circular polarization scheme.

According to an embodiment, the electronic device 101 may select one of the left revolving circular polarization scheme and the right revolving circular polarization scheme, and be operatively connected in communication with the satellite device based on a communication signal of the selected circular polarization scheme. For example, the electronic device 101 may generate a second communication signal rotating in a direction opposite to that of a first communication signal (e.g., a signal of the circular polarization scheme) transmitted from the satellite device, and perform a communication connection with the satellite device. For example, in the case that the first communication signal is a left revolving circular polarization signal, the second communication signal may be determined to a right revolving circular polarization signal.

FIG. 6B is a graph illustrating an example process of implementing a communication signal of a circular polarization scheme based on a first antenna signal and a second antenna signal generated using the communication circuit of FIG. 6A according to various embodiments.

According to an embodiment, the electronic device 101 may include a first antenna (e.g., the first antenna 411 of FIG. 4) that generates a first antenna signal 631 having polarization according to a first direction based on a linear polarization scheme, and a second antenna (e.g., the second antenna 412 of FIG. 4) that generates a second antenna signal 632 having polarization according to a second direction different from the first direction. The first antenna 411 and the second antenna 412 may each generate a communication signal of a linear polarization scheme. The first antenna 411 may transmit the first antenna signal 631, and the second antenna 412 may transmit the second antenna signal 632. For example, the linear polarization scheme may include a polarization scheme in which a vector direction of an electric field (e.g., electric field component) vibrates in a single one-dimensional direction. The first antenna signal 631 may include a horizontal polarization signal vibrating based on a first direction 641. The second antenna signal 632 may include a vertical polarization signal vibrating based on a second direction 642. The first antenna signal 631 according to the horizontal polarization scheme and the second antenna signal 632 according to the vertical polarization scheme may be orthogonal to each other. According to an embodiment, in the case that the first antenna signal 631 and the second antenna signal 632 are transmitted in substantially the same direction, the electronic device 101 may implement a communication signal 640 according to the circular polarization scheme based on the first antenna signal 631 and the second antenna signal 632.

With reference to FIG. 6B, the processor (e.g., the processor 120 of FIG. 4, the CP 601 of FIG. 6A) of the electronic device 101 may shift a phase of at least one of the first antenna signal 631 or the second antenna signal 632. With reference to FIG. 6A, a phase shifter (e.g., the phase shifter 609 of FIG. 6A) may be included in an antenna module (e.g., the antenna module 620 of FIG. 6A). For example, the phase shifter 609 may be disposed in a movement path of a communication signal (e.g., second antenna signal) transmitted to the second antenna 412 and at least partially shift a phase of the communication signal. For example, the processor 120 may generate a phase difference of about ±90 degrees (e.g., Δ/4) 633 or about ±270 degrees (e.g., 3*λ/4) between the first antenna signal 631 and the second antenna signal 632 based on the phase shifter 609. For example, the processor 120 may at least partially shift the phase of the second antenna signal 632. With reference to FIG. 6B, a phase difference of about 90 degrees (e.g., Δ/4) 633 between the first antenna signal 631 and the second antenna signal 632 is generated, but it is not limited thereto.

According to an embodiment, the circular polarization scheme may include a left revolving circular polarization scheme that revolves along the left direction and/or a right revolving circular polarization scheme that revolves along the right direction. For example, the processor 120 may determine the type of the circular polarization scheme based on a phase difference between the first antenna signal 631 and the second antenna signal 632. According to an embodiment, the electronic device 101 may identify a circular polarization scheme supported by a first external electronic device (e.g., satellite device), shift a phase of the second antenna signal 632 based on the identified circular polarization scheme, and generate a communication signal corresponding to the identified circular polarization scheme as the phase of the second antenna signal 632 is shifted.

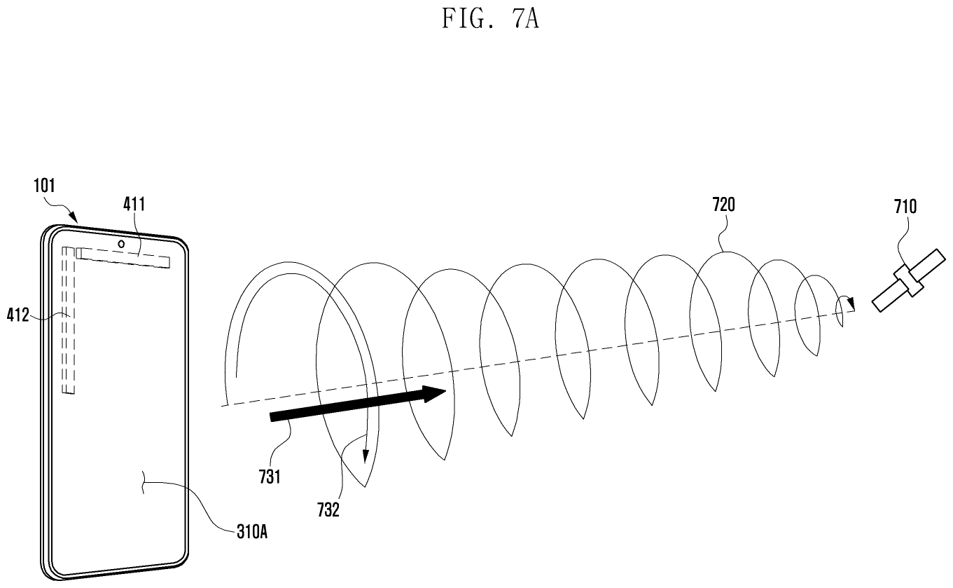

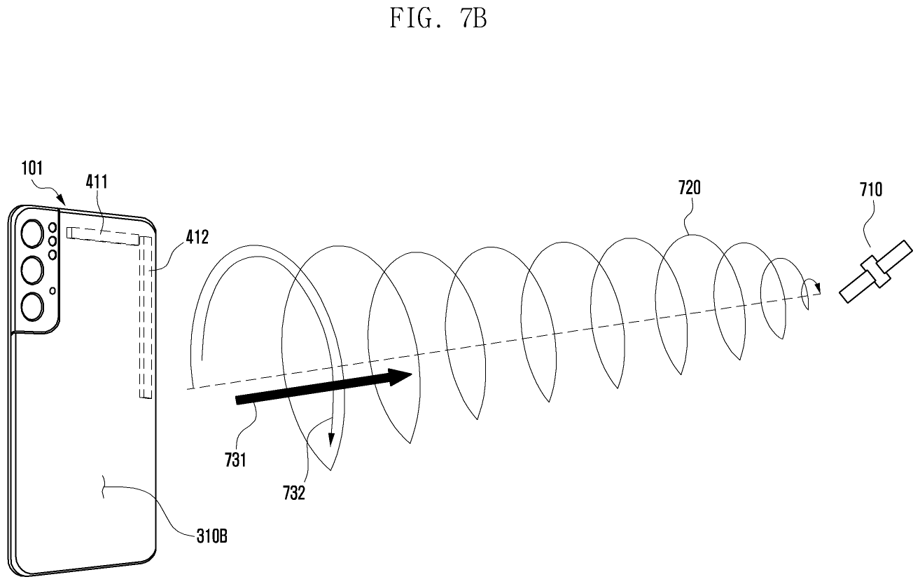

FIG. 7A is a diagram illustrating an example scenario in which an electronic device is connected in communication with a satellite device based on a circular polarization scheme when the electronic device is in a first state (e.g., a state in which a front surface of the electronic device faces the satellite device) according to various embodiments.

FIG. 7B is a diagram illustrating an example scenario in which an electronic device is connected in communication with a satellite device based on a circular polarization scheme when the electronic device is in a second state (e.g., a state in which a rear surface of the electronic device faces the satellite device) according to various embodiments.

An electronic device 101 of FIGS. 7A and 7B may be at least partially similar to the electronic device 101 of FIG. 1 and the electronic device 300 of FIGS. 2 and 3, or may further include other components of the electronic device 101.

According to an embodiment, the electronic device 101 may be connected in communication with a first external electronic device 710 (e.g., satellite device) using an antenna module (e.g., the antenna module 197 of FIG. 4, the first antenna 411 of FIG. 4, the second antenna 412 of FIG. 4) supporting a linear polarization scheme. The electronic device 101 may include a plurality of antennas (e.g., the first antenna 411, the second antenna 412) for communication with the first external electronic device 710. The first antenna 411 may generate a communication signal of a horizontal polarization scheme (e.g., first antenna signal) in which a propagation direction of an electromagnetic wave vibrates parallelly based on a horizontal line, and the second antenna 412 may generate a communication signal of a vertical polarization scheme (e.g., second antenna signal) in which a propagation direction of an electromagnetic wave vibrates vertically based on a horizontal line. The first antenna 411 and the second antenna 412 may be disposed in the form orthogonal to each other. For example, a vibration direction of the first antenna signal generated through the first antenna 411 and a vibration direction of the second antenna signal generated through the second antenna 412 may be orthogonal to each other.

According to an embodiment, the electronic device 101 may at least partially shift a phase of at least one of a first antenna signal or a second antenna signal, and generate a circular polarization scheme communication signal 720 based on the first antenna signal and the second antenna signal. The electronic device 101 may transmit the circular polarization scheme communication signal 720 to the first external electronic device 710 along a direction 731 toward a location of the first external electronic device 710, and establish a communication connection with the first external electronic device 710 based on the communication signal of a circular polarization scheme.

With reference to FIGS. 7A and 7B, the electronic device 101 may identify a state (e.g., first state, second state) thereof using a motion sensor (e.g., the motion sensor 430 of FIG. 4). For example, the state of the electronic device 101 may include a first state in which the front surface (e.g., the first surface 310A of FIG. 2) of the electronic device 101 is disposed facing the first external electronic device 710 and/or a second state in which the rear surface (e.g., the second surface 310B of FIG. 3) of the electronic device 101 is disposed facing the first external electronic device 710.

With reference to FIGS. 7A and 7B, the first external electronic device 710 may generate a communication signal based on a left revolving circular polarization scheme, and be in a state of transmitting the generated communication signal to the electronic device 101. The electronic device 101 may identify a left revolving circular polarization scheme supported by the first external electronic device 710 based on satellite related information (e.g., the satellite related information 421 of FIG. 4) stored in the memory (e.g., the memory 130 of FIG. 4), and generate a communication signal according to a right revolving circular polarization scheme different from a polarization scheme supported by the first external electronic device 710 based on the first antenna 411 and the second antenna 412. For example, a right revolving circular polarization signal according to the right revolving circular polarization scheme may include a signal rotating clockwise based on the electronic device 101. As another example, a left revolving circular polarization signal according to a left revolving circular polarization scheme may include a signal rotating counterclockwise based on the electronic device 101.

With reference to FIG. 7A, the electronic device 101 may identify that the electronic device 101 is in a first state and that the first external electronic device 710 supports a left revolving circular polarization scheme, and generate a communication signal according to a right revolving circular polarization scheme 732 along a direction 731 toward the first external electronic device 710 through the front surface 310A of the electronic device 101. According to an embodiment, the electronic device 101 may establish a communication connection with the first external electronic device 710 based on a communication signal according to the right revolving circular polarization scheme 732.

With reference to FIG. 7B, the electronic device 101 may identify that the electronic device 101 is in a second state and that the first external electronic device 710 supports a left revolving circular polarization scheme, and generate a communication signal according to the right revolving circular polarization scheme 732 along a direction 731 toward the first external electronic device 710 through the rear surface 310B thereof. According to an embodiment, the electronic device 101 may establish a communication connection with the first external electronic device 710 based on a communication signal according to the right revolving circular polarization scheme 732.

A method according to an embodiment may include an operation of identifying a first location of an electronic device 101 through a communication module (e.g., the communication module 190 of FIG. 4) including a first antenna (e.g., the first antenna 411 of FIG. 4) and a second antenna (e.g., the second antenna 412 of FIG. 4); an operation of identifying a second location of a first external electronic device connected in communication through the communication module 190 based on satellite related information (e.g., the satellite related information 421 of FIG. 4) stored in a memory (e.g., the memory 130 of FIG. 4); an operation of calculating a relative direction with respect to the first external electronic device disposed at the second location using the electronic device 101 disposed at the first location as a reference point; an operation of identifying a state of the electronic device 101 according to the calculated direction using a motion sensor (e.g., the motion sensor 430 of FIG. 4); an operation of determining one circular polarization scheme among a first circular polarization scheme rotating along the first direction or a second circular polarization scheme rotating along the second direction, which is a direction opposite to the first direction based on the first antenna 411 and the second antenna 412 corresponding to the identified state of the electronic device 101; and an operation of generating a communication signal corresponding to the determined circular polarization scheme.

An operation of generating a communication signal corresponding to a circular polarization scheme according to an embodiment may include an operation of shifting a phase of a second antenna signal transmitted to a second antenna 412 using a phase shifter 609 connected to the second antenna 412; and an operation of generating a communication signal corresponding to a circular polarization scheme based on a first antenna signal corresponding to a first antenna 411 and a second antenna signal corresponding to the second antenna 412 and whose phase is shifted.

The method according to an embodiment may further include an operation of shifting the phase of the second antenna signal so that a phase difference occurs by about 90 degrees or about 270 degrees based on the first antenna signal using a phase shifter 609.

A method according to an embodiment may further include an operation of determining one of a first circular polarization scheme (e.g., right revolving circular polarization scheme) and a second circular polarization scheme (e.g., left revolving circular polarization scheme) based on a phase difference value between a first antenna signal and a second antenna signal; and an operation of generating a communication signal corresponding to the determined circular polarization scheme.

A method according to an embodiment may further include an operation of identifying a circular polarization scheme supported by a first external electronic device; and an operation of shifting a phase of a second antenna signal transmitted to a second antenna 412 using a phase shifter 609 so that a communication signal corresponding to a second circular polarization scheme different from the first circular polarization scheme is generated in the case that the identified circular polarization scheme is the first circular polarization scheme.

An operation of generating a communication signal corresponding to a circular polarization scheme according to an embodiment may include an operation of identifying a first state in which a first surface 310A of an electronic device 101 faces a first external electronic device using a motion sensor 430; and an operation of generating a communication signal of a circular polarization scheme along a direction toward the first external electronic device through the first surface 310A.

An operation of generating a communication signal corresponding to a circular polarization scheme according to an embodiment may include an operation of identifying a second state in which a second surface 310B of the electronic device 101 faces a first external electronic device using a motion sensor 430; and an operation of generating a communication signal of a circular polarization scheme along a second direction toward the first external electronic device through the second surface 310B.

Satellite related information 421 according to an embodiment may include at least one of direction information, location information, trajectory information, communication signal related information, information on supporting communication signals, or information on a polarization scheme of communication signals, in relation to at least one satellite device located in space. The first external electronic device may include at least one satellite device.

According to an embodiment, the first antenna 411 and the second antenna 412 may each generate a communication signal of a linear polarization scheme. A first polarization direction of the first antenna signal corresponding to the first antenna 411 and a second polarization direction of the second antenna signal corresponding to the second antenna 412 may be orthogonal to each other.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. It is intended that features described with respect to separate embodiments, or features recited in separate claims, may be combined unless such a combination is explicitly specified as being excluded or such features are incompatible. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, variations and alternatives of the various example embodiments may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a communication module including a first antenna and a second antenna, and configured to implement a communication signal of a circular polarization scheme based on the first antenna and the second antenna;
a motion sensor;
memory storing instructions; and
at least one processor, comprising processing circuitry, operatively connected to the communication module, the motion sensor, and the memory,
wherein the instructions, when executed by the at least one processor, individually and/or collectively, cause the electronic device to:
identify a first location of the electronic device through the communication module,
identify a second location of a first external electronic device connected in communication through the communication module based on satellite related information stored in the memory,
calculate a relative direction with respect to the first external electronic device disposed at a second location using the electronic device disposed at the first location as a reference point,
identify a state of the electronic device according to the calculated direction using the motion sensor,
determine one of a first circular polarization scheme rotating along the first direction or a second circular polarization scheme rotating along a second direction opposite to the first direction based on the first antenna and the second antenna corresponding to the identified state of the electronic device, and
generate a communication signal corresponding to the determined circular polarization scheme.

2. The electronic device of claim 1, further comprising a phase shifter comprising circuitry connected to the second antenna,
wherein the instructions, when executed by the at least one processor, individually and/or collectively, cause the electronic device to:
shift a phase of a second antenna signal transmitted to the second antenna using the phase shifter, and
generate a communication signal corresponding to the determined circular polarization scheme based on the first antenna signal corresponding to the first antenna and the second antenna signal corresponding to the second antenna and in which the phase is shifted.

3. The electronic device of claim 1, wherein the instructions, when executed by the at least one processor, individually and/or collectively, cause the electronic device to shift a phase of the second antenna signal so that a phase difference of about 90 degrees or about 270 degrees occurs based on the first antenna signal using the phase shifter.

4. The electronic device of claim 1, wherein the instructions, when executed by the at least one processor, individually and/or collectively, cause the electronic device to:
determine one of the first circular polarization scheme and the second circular polarization scheme based on a phase difference value between the first antenna signal and the second antenna signal, and
generate a communication signal corresponding to the determined circular polarization scheme.

5. The electronic device of claim 1, wherein the instructions, when executed by the at least one processor, individually and/or collectively, cause the electronic device to:
identify a circular polarization scheme supported by the first external electronic device, and
shift a phase of a second antenna signal transmitted to the second antenna using the phase shifter, wherein a communication signal corresponding to a second circular polarization scheme different from the first circular polarization scheme is generated, based on the identified circular polarization scheme being the first circular polarization scheme.

6. The electronic device of claim 1, wherein the instructions, when executed by the at least one processor, individually and/or collectively, cause the electronic device to:
identify a first state in which a first surface of the electronic device faces the first external electronic device using the motion sensor, and
generate a communication signal of the determined circular polarization scheme along a direction toward the first external electronic device through the first surface.

7. The electronic device of claim 1, wherein the instructions, when executed by the at least one processor, individually and/or collectively, cause the electronic device to:
identify a second state in which a second surface of the electronic device faces the first external electronic device using the motion sensor, and
generate a communication signal of the determined circular polarization scheme along a direction toward the first external electronic device through the second surface.

8. The electronic device of claim 1, wherein the motion sensor comprises at least one of a proximity sensor, an acceleration sensor, or a gyro sensor.

9. The electronic device of claim 1, wherein the satellite related information comprises at least one of direction information, location information, trajectory information, communication signal related information, information on supporting communication signals, and/or information on a polarization scheme of communication signals, in relation to at least one satellite device located in space, and
the first external electronic device comprises at least one satellite device.

10. The electronic device of claim 1, wherein the first antenna and the second antenna are each configured to generate a communication signal of a linear polarization scheme, and
wherein a first polarization direction of a first antenna signal corresponding to the first antenna and a second polarization direction of a second antenna signal corresponding to the second antenna are orthogonal to each other.

11. The electronic device of claim 1, wherein the instructions, when executed by the at least one processor, individually and/or collectively, cause the electronic device to:
acquire GPS information from a GPS satellite device connected through the communication module, and
identify a first location of the electronic device based on the acquired GPS information.

12. A method, comprising:
identifying a first location of an electronic device through a communication module including a first antenna and a second antenna;
identifying a second location of a first external electronic device connected in communication through the communication module based on satellite related information stored in a memory;
calculating a relative direction with respect to the first external electronic device disposed at the second location using the electronic device disposed at the first location as a reference point;
identifying a state of the electronic device according to the calculated direction using a motion sensor;
determining one of a first circular polarization scheme rotating along a first direction or a second circular polarization scheme rotating along a second direction opposite to the first direction based on the first antenna and the second antenna corresponding to the identified state of the electronic device; and
generating a communication signal corresponding to the determined circular polarization scheme.

13. The method of claim 12, wherein generating a communication signal corresponding to the circular polarization scheme comprises:
shifting a phase of a second antenna signal transmitted to the second antenna using a phase shifter connected to the second antenna; and
generating a communication signal corresponding to the determined circular polarization scheme based on a first antenna signal corresponding to the first antenna and a second antenna signal corresponding to the second antenna and in which the phase is shifted.

14. The method of claim 12, further comprising shifting a phase of the second antenna signal so that a phase difference of about 90 degrees or about 270 degrees occurs based on the first antenna signal using the phase shifter.

15. The method of claim 12, further comprising:
determining one of the first circular polarization scheme and the second circular polarization scheme based on a phase difference value between the first antenna signal and the second antenna signal; and
generating a communication signal corresponding to the determined circular polarization scheme.

16. The method of claim 12, further comprising:
identifying a circular polarization scheme supported by the first external electronic device; and
shifting a phase of a second antenna signal transmitted to the second antenna using the phase shifter, wherein a communication signal corresponding to a second circular polarization scheme different from the first circular polarization scheme is generated, based on the identified circular polarization scheme being the first circular polarization scheme.

17. The method of claim 12, wherein generating a communication signal corresponding to the circular polarization scheme comprises:
identifying a first state in which a first surface of the electronic device faces the first external electronic device using the motion sensor; and
generating a communication signal of the determined circular polarization scheme along a direction toward the first external electronic device through the first surface.

18. The method of claim 12, wherein generating a communication signal corresponding to the circular polarization scheme comprises:
identifying a second state in which a second surface of the electronic device faces the first external electronic device using the motion sensor; and
generating a communication signal of the determined circular polarization scheme along a direction toward the first external electronic device through the second surface.

19. The method of claim 12,
wherein the satellite related information comprises at least one of direction information, location information, trajectory information, communication signal related information, information on supporting communication signals, and/or information on a polarization scheme of communication signals, in relation to at least one satellite device located in space, and
wherein the first external electronic device comprises at least one satellite device.

20. The method of claim 12,
wherein the first antenna and the second antenna are each configured to generate a communication signal of a linear polarization scheme, and
wherein a first polarization direction of a first antenna signal corresponding to the first antenna and a second polarization direction of a second antenna signal corresponding to the second antenna are orthogonal to each other.
